(19) United States
(12) Patent Application Publication
(10) Pub. No.: US 2026/0257248 A1
(43) Pub. Date: Sep. 3, 2026

(54) MAGNETIC SCRAPER ASSEMBLY

(71) Applicant: Sons of Asphalt, LLC, Andalusia, IL (US)

(72) Inventor: Christopher M. Dowell, Taylor Ridge, IL (US)

(73) Assignee: Sons of Asphalt, LLC, Andalusia, IL (US)

(21) Appl. No.: 19/066,996

(22) Filed: Feb. 28, 2025

(51) Int. Cl. B08B 1/16; B25G 1/10; E01C 23/00; F16B 1/00

(52) U.S. Cl. CPC B08B 1/165; B25G 1/102; E01C 23/00; F16B 1/00; F16B 2200/83

(57) ABSTRACT

The present disclosure relates to a magnetic scraper assembly configured for attachment to various hand tools to facilitate efficient removal of hardened asphalt and other difficult substances. The scraper includes a handle, a scraper blade, and a full tang enclosed by the handle for durability. A magnetic connection assembly, having a permanent magnet housed in a mounting bracket, enables secure, removable attachment to a hand tool. The scraper is positioned on the same tool being used, ensuring quick accessibility. Optionally, the handle may include a magnet for direct attachment to metal-handled tools or other metal surfaces. An interchangeable system enables the scraper to be used across multiple tools, improving efficiency and reducing downtime. A method of use involves attaching the scraper via the magnetic connection, detaching it for cleaning, and reattaching it for storage. Alternative embodiments incorporate replaceable blades, additional magnets, and contoured mounting surfaces for enhanced adaptability.

### FIELD OF THE INVENTION

The present invention relates to a magnetic scraper assembly. More particularly, but not exclusively, the present invention relates to a scraper and magnetic connection assembly configured for attachment to various hand tools for improved accessibility and efficiency in removing hardened asphalt and other difficult substances from unwanted surfaces.

### BACKGROUND

Traditional scrapers used for removing hardened asphalt and other difficult substances from tools, equipment, and surfaces suffer from several drawbacks. These scrapers are often not readily accessible when needed, requiring workers to retrieve a separate tool, leading to inefficiencies in workflow. Additionally, conventional scrapers lack a secure and convenient attachment mechanism for easy storage on hand tools, increasing the likelihood of misplacement. Furthermore, existing scrapers do not always provide a high-strength, durable construction capable of withstanding repeated use in demanding environments.

Therefore, what is needed is a scraper with an integrated magnetic connection assembly that allows for secure, removable attachment to a variety of hand tools, ensuring quick accessibility and reliable performance in demanding applications such as asphalt removal.

### SUMMARY

Therefore, it is a primary object, feature, or advantage of the present invention to improve over the state of the art.

It is a further object, feature, or advantage of the present invention to provide a magnetic scraper assembly that can be securely and removably attached to various hand tools via a magnetic connection assembly.

It is a still further object, feature, or advantage of the present invention to improve efficiency in asphalt removal operations by ensuring that a scraper is readily accessible on a hand tool being used in the job.

Another object, feature, or advantage is to provide a scraper with a high-strength, rigid scraper blade and full tang handle construction for durability and reliable performance.

Yet another object, feature, or advantage is to incorporate an optional magnet into the scraper handle for direct attachment to metal-handled tools, enhancing versatility and storage convenience.

According to at least one aspect, a magnetic scraper assembly configured for attachment to a variety of asphalt working tools is disclosed. The scraper assembly includes, for example, a scraper having a handle and a scraper blade, wherein the scraper blade is made from a rigid, high-strength material capable of removing hardened asphalt and other difficult substances from unwanted surfaces. The scraper assembly also, for example, includes a full tang extending from the scraper blade through the handle, wherein the handle generally encloses the tang and is constructed from high-strength material. A magnetic connection assembly can also be included where the magnetic connection assembly includes a high-strength permanent magnet housed in a mounting bracket. The magnetic connection assembly can be a separate component from the scraper and configured for attachment to a hand tool. In one aspect, the magnetic connection assembly is configured to attach the scraper to the hand tool, allowing for quick attachment and detachment.

According to at least one other aspect, a system is disclosed that includes a hand tool, a magnetic scraper having a handle and a scraper blade, wherein the scraper blade is made from a rigid, high-strength material capable of removing substances from unwanted surfaces, a full tang extending from the scraper blade through the handle, wherein the handle generally encloses the tang and is constructed from high-strength material, and a magnetic connection assembly including a high-strength permanent magnet, wherein the magnetic connection assembly is configured to attach the scraper to the hand tool, allowing for quick attachment and detachment.

According to at least another aspect, a method for using a magnetic scraper assembly in operations using hand tools is disclosed. The method includes, in at least one exemplary aspect, steps such as providing a magnetic scraper comprising a handle, a scraper blade, and a full tang enclosed by the handle, wherein the scraper blade is made from a rigid, high-strength material, removably attaching the magnetic scraper via a magnetic connection, decoupling the magnetic scraper by breaking the magnetic connection, using the magnetic scraper to remove substances from unwanted surfaces, and re-coupling the magnetic connection for stowing the magnetic scraper.

One or more of these and/or other objects, features, or advantages of the present invention will become apparent from the specification and claims that follow. No single aspect need provide each and every object, feature, or advantage. Different aspects may have different objects, features, or advantages. Therefore, the present invention is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is a perspective view of a magnetic scraper assembly, illustrating the scraper blade, handle, and full tang enclosed by the handle in accordance with an exemplary aspect.

FIG. 2 is a side view of the magnetic scraper assembly.

FIG. 3 is an exploded view showing the magnetic scraper assembly.

FIG. 4 is a perspective view of a magnetic connection assembly, illustrating the mounting bracket and magnet in accordance with an exemplary aspect.

FIG. 5 is a front view of the magnetic connection assembly.

FIG. 6 is an exploded view showing the magnetic connection assembly.

FIG. 7 is a perspective view of the magnetic scraper assembly, magnetic connection assembly, and hand tool.

FIG. 8 is a perspective view of the magnetic scraper assembly and magnetic connection assembly in accordance with another illustrative aspect.

FIG. 9 is a diagrammatic representation of a method for using the magnetic scraper assembly in accordance with at least one illustrative aspect.

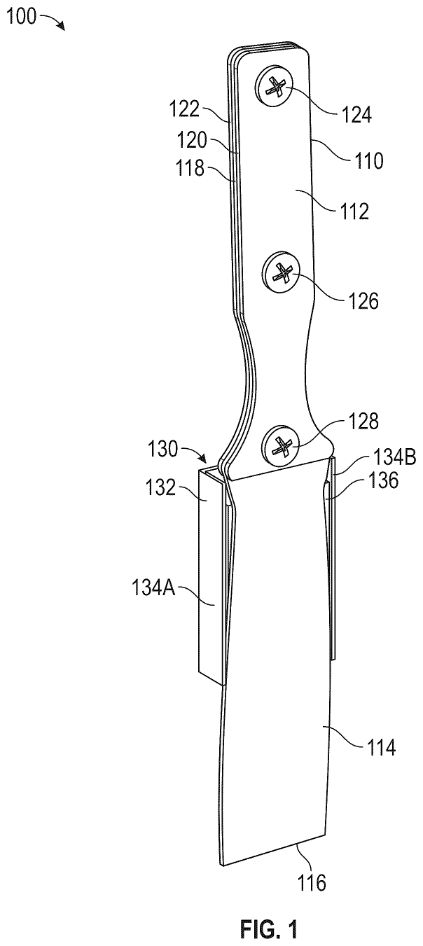

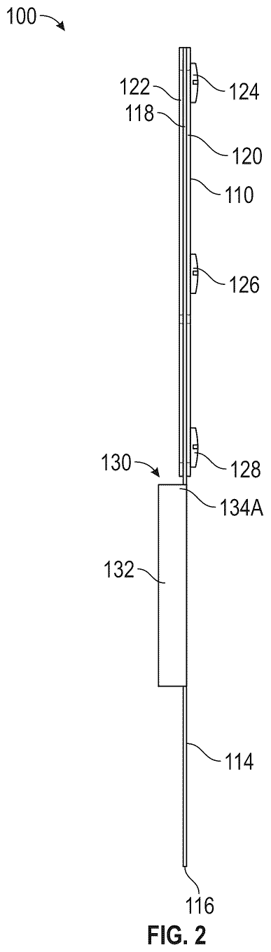

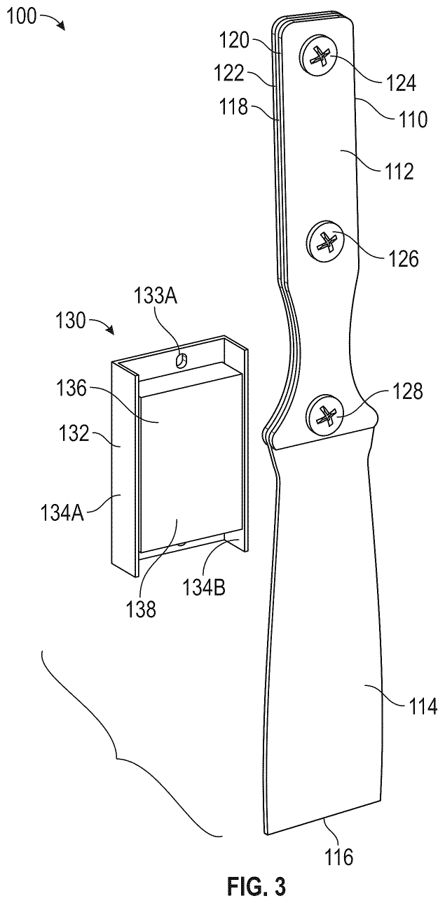

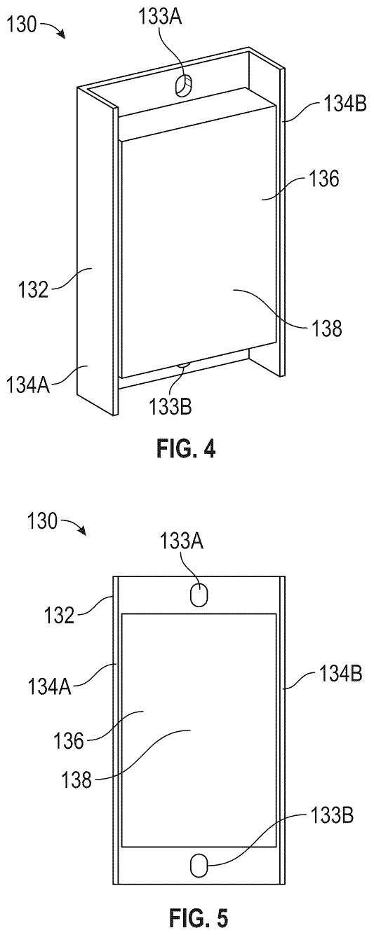

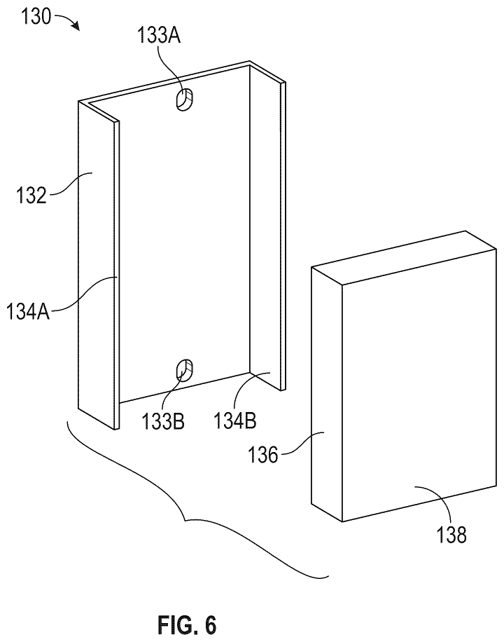

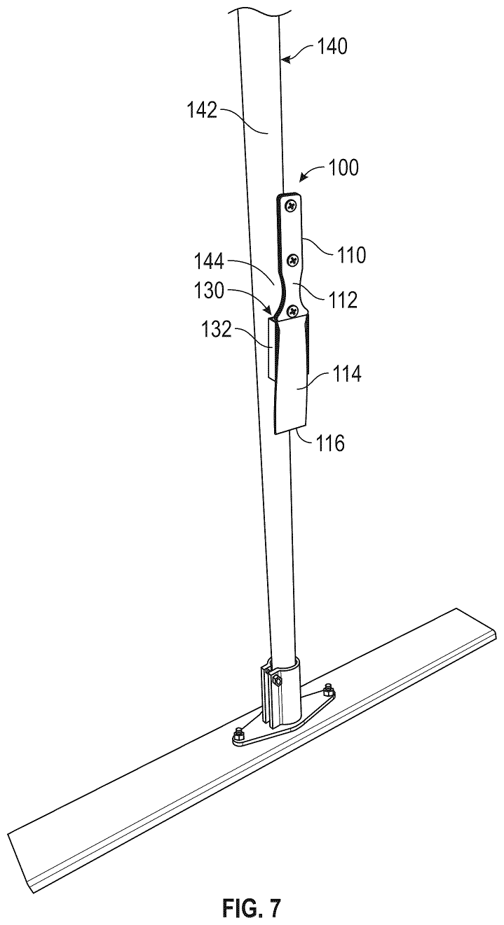

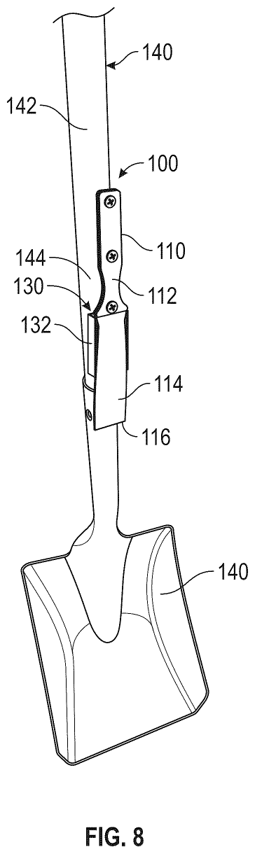

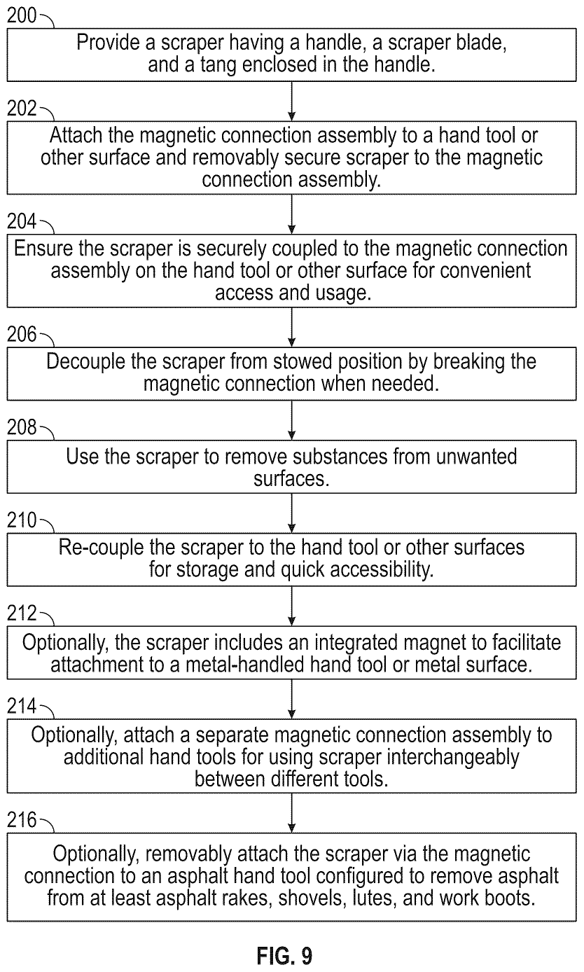

### DETAILED DESCRIPTION

The present invention is directed to a magnetic scraper assembly 100 configured for attachment to a variety of hand tools 140 to facilitate efficient removal of hardened asphalt and other difficult substances from unwanted surfaces. The magnetic scraper assembly 100 includes a scraper 110, a handle 112, a scraper blade 114, a blade edge 116, a full tang 118, opposing grip members 120, 122 secured together through tang 118 via grip connectors 124, 126, 128, and a magnetic connection assembly 130. Grip connectors 124, 126, 128 can be removed to replace blade 114 and/or one or both of opposing grip members 120, 122. The magnetic connection assembly 130 includes a mounting bracket 132 with opposing bracket walls 134A, 134B and a magnet 136 disposed therebetween with an outward facing magnetic coupling surface 138. The components are designed for durability, accessibility, and ease of use in demanding environments such as asphalt paving operations.

### Scraper Construction and Materials

Scraper 110 includes handle 112 made of opposing grip members 120, 122 and scraper blade 114 terminating in blade edge 116. Handle 112 with its opposing grip members 120, 122 is designed to enclose tang 118, providing increased strength and durability. Scraper blade 114, tang 118, and opposing grip members 120, 122 can be made from a high-strength, rigid material such as stainless steel, hardened steel, or a corrosion-resistant alloy to ensure long-term effectiveness. Alternatively, scraper blade 114 can be constructed from composite materials or other abrasion-resistant materials to accommodate different working conditions.

Handle 112 with its opposing grip members 120, 122 may be ergonomically shaped for improved user comfort and control. In some aspects, the handle 112 with opposing grip members 120, 122 incorporates a textured or rubberized grip to enhance handling, particularly in wet or greasy environments. Additionally, the handle 112 may feature an integrated magnet, such as magnet 136 for direct attachment to a handle 112 of a metal-handled hand tool(s) 140. The scraper 110 is configured to remove substances from unwanted surfaces, including asphalt from rakes, shovels, lutes, and boots.

### Magnetic Connection Assembly

Magnetic connection assembly 130 includes permanent magnet 136 housed within mounting bracket 132. Mounting bracket 132 may include mounting points 133A, 133B for attaching mounting bracket 132 to a hand tool 140 via screws. In another aspect, mounting bracket 132 is attached via ring clamps, welding, or adhesive bonding. Alternatively, mounting bracket 132 can be secured to the tool or other surface using quick-release clamps or other detachable fasteners to provide flexible attachment options. Mounting bracket 132 may be configured with a flat or contoured mounting surface for attaching to flat or contoured surfaces.

Permanent magnet 136 generates a strong magnetic force, ensuring that the scraper 110 remains securely attached to hand tool 140 or other attachment surface when not in use. Magnet 136 may be encased in mounting bracket 132 forming a protective casing with one or more edges/walls such as bracket walls 134A, 134B to prevent debris accumulation and prolong the life of the assembly. In some aspects, the mounting bracket 132 may include a contoured mounting surface to improve contact with a contoured mounting surface 144 of hand tool 140, such as a shovel, rake handle, or other type of hand tool. Bracket walls 134A, 134B may be configured to have a height to exceed the height of magnet 136 whereby bracket walls 134A, 134B coral scraper blade 114 when scraper 110 is magnetically secured to magnet 136 of magnetic connection assembly 130.

Magnetic connection assembly 130 is attached to mounting surface 144 on handle 142 of hand tool 140. Scraper 110 is positioned on the same tool, such as hand tool 140, being used for a job so that it is readily and quickly accessible. Optionally, handle 112 with opposing grip members 120, 122 may be configured to include an integrated magnet, similar to magnet 136, for removably attaching it to metal surfaces, such as a metal-handled hand tool 140 or other metal surfaces. In such cases, magnet 136 may have a contoured magnetic coupling surface 138 to ensure secure attachment to a contoured hand tool surface. Magnetic coupling surface 138 of magnet 136 may also be configured in such cases with a convex, concave, or other contours to securely attach to an opposing mounting surface 144 having an opposing contour. In the case of an integrated magnet in handle 122 or opposing grip members 120, 122, mounting bracket 132 may be removed or configured to aid in integrating magnet 136. In the case where mounting bracket 132 is configured to integrate magnet 136 in handle 112 and opposing grip members 120, 122, bracket walls 134A-B may be similarly contoured or shaped to accommodate surface alterations to magnetic coupling surface 138 or the surface configuration of a surface the magnet 136 attaches to.

### Attachment and Use

Referring to the flowchart steps, the method for using the magnetic scraper assembly 100 begins at step 200, where scraper 110 is provided, featuring handle 112 with opposing grip members 120, 122, scraper blade 114 with blade edge 116, and full tang 118. In step 202, mounting bracket 132 of magnetic connection assembly is attached to, for example, mounting surface 144 of handle 142 of hand tool 140, or another mounting surface, and scraper 110 is attached to hand tool 140 using magnet 136 in magnetic connection assembly 130. The secure attachment of scraper 110 to hand tool 140 in step 204 allows for quick access and secure storage during use.

At step 206, the user decouples scraper 110 from its stowed position on magnet 136 which is attached to another surface, such as mounting surface 144 on handle 142 of hand tool 140, by breaking the magnetic connection. Alternatively, if magnet 136 is configured or integrated in handle 112 with opposing grip members 120, 122 of scraper 110, the user decouples scraper 110 and the integrated magnet from a metal surface, such as a metal mounting surface 144, such as on handle 142 of hand tool 140 as in step 212. Breaking the magnetic connection and separating scraper 110 from magnet 136 or scraper 110 with integrated magnet from hand tool 140 enables immediate use of the scraper blade 114 for removing hardened asphalt and other substances from unwanted surfaces, as described in step 208. The user may apply force manually or utilize different scraping angles depending on the nature of the debris being removed. In one aspect, as in step 216, a user removably attaches scraper 110 via magnetic connection to an asphalt hand tool 140 configured to remove asphalt from at least asphalt rakes, shovels, lutes, and work boots.

Once the scraping task is complete, step 210 involves re-coupling the scraper 110 to the hand tool 140 in its stowed position for storage and accessibility. Optionally, at step 214, an additional magnetic connection assembly 130 can be installed on alternative hand tools 140, allowing the scraper 110 to be used interchangeably between different tools.

### Alternative Configurations and Aspects

In an alternative aspect, the magnetic scraper 110 may include a replaceable scraper blade 114, allowing users to swap out worn blades for new ones by disassembling opposing grip members 120, 122 by removing grip connectors 124, 126, 128. The blade 114 may be secured using grip connectors 124, 126, 128 such as screws, a quick-release mechanism, or other fastening methods.

Another variation includes integrating multiple magnets within handle 112 to provide enhanced attachment strength. In some cases, the magnet 136 integrated in handle 112 or attached within mounting bracket 132 may be adjustable or removable to accommodate different working conditions.

Furthermore, the magnetic connection assembly 130 may incorporate a locking mechanism, such as a mechanical latch or detent system, to provide additional security when scraper 110 is attached to hand tool 140.

Different sizes and shapes of scraper blades 114 and blade edges 116 may be utilized to optimize scraping efficiency for various applications. For example, a wider scraper blade 114 may be preferable for removing asphalt from flat surfaces, while a narrower blade may be suited for cleaning between rake tines.

At least one aspect of the present invention includes a magnetic scraper assembly 100 configured for attachment to a variety of asphalt working tools, such as hand tools 140. Magnetic scraper assembly 100 includes scraper 110 having handle 112 and scraper blade 114, wherein scraper blade 114 is made from a rigid, high-strength material capable of removing hardened asphalt and other difficult substances from unwanted surfaces. Tang 118 extends from the scraper blade 114 through handle 112, wherein opposing grip members 120, 122 of handle 110 generally encloses tang 118 and tang 118 is constructed from high-strength material. Magnetic connection assembly 130 includes a high-strength permanent magnet 136 housed in mounting bracket 132. Magnetic connection assembly 130 is a separate component from magnetic scraper assembly 100 and is configured for attachment to a surface, such as mounting surface 144 on hand tool 140. Magnetic connection assembly 100 is configured to attach scraper 110 to hand tool 140, allowing for quick attachment and detachment.

In at least one other aspect, a system of the present invention includes hand tool 140 scraper 110 with handle 112 and scraper blade 114, wherein scraper blade 114 is made from a rigid, high-strength material capable of removing substances from unwanted surfaces. Tang 118 extending from the scraper blade 114 through handle 112, wherein handle 112 with opposing grip members 120, 122 generally encloses the tang 118 and tang 118 is constructed from high-strength material. Magnetic connection assembly 130 includes magnet 136, such as a high-strength permanent magnet. Magnetic connection assembly 130 is configured to attach scraper 110 to the hand tool 140, allowing for quick attachment and detachment.

In yet another aspect, a method for using magnetic scraper assembly 100 in operations using hand tools 140 is disclosed. The method includes providing magnetic scraper 110 having handle 112, scraper blade 114, blade edge 116, and tang 118 enclosed by the handle 112 with opposing grip members 120, 122, wherein scraper blade 114 is made from a rigid, high-strength material. In at least one step, magnetic scraper assembly 100 and hand tool 140 can be used by removably attaching magnetic scraper 110 via a magnetic connection resulting from magnet 136 and metal components of magnetic scraper assembly 100, such as blade 114. Decoupling the magnetic scraper 110 may be performed by breaking the magnetic connection between magnet 136 and hand tool 140 or magnet 136 and a metal surface. Using the magnetic scraper 110 to remove substances from unwanted surfaces, such as by decoupling scraper 110 from hand tool 140 for removing difficult to remove substances such as asphalt from hand tool 140 or other unwanted surfaces. Re-coupling the magnetic connection of magnetic scraper assembly 100 and magnetic connection assembly 130 may be performed for stowing magnetic scraper 110.

The invention is not to be limited to the particular aspects described herein. In particular, the invention contemplates numerous variations in a magnetic scraper assembly. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of aspects, processes or methods of the invention. It is understood that any other modifications, substitutions, and/or additions can be made, which are within the intended spirit and scope of the invention.

What is claimed is:

1. A magnetic scraper assembly configured for attachment to a variety of asphalt working tools, the scraper assembly comprising:
a scraper having a handle and a scraper blade, wherein the scraper blade is made from a rigid, high-strength material capable of removing hardened asphalt and other difficult substances from unwanted surfaces;
a full tang extending from the scraper blade through the handle, wherein the handle generally encloses the tang and is constructed from high-strength material;
a magnetic connection assembly including a high-strength permanent magnet housed in a mounting bracket, the magnetic connection assembly being a separate component from the scraper and configured for attachment to a hand tool;
wherein the magnetic connection assembly is configured to attach the scraper to the hand tool, allowing for quick attachment and detachment.

2. The magnetic scraper assembly of claim 1, wherein the scraper is positioned on the same hand tool being used for a job so that it is readily and quickly accessible.

3. The magnetic scraper assembly of claim 1, wherein the mounting bracket is configured to be bolted or welded onto the hand tool or other accessible surface at a work site.

4. The magnetic scraper assembly of claim 1, wherein the scraper handle comprises an ergonomic reinforced grip to improve user performance and handling.

5. The magnetic scraper assembly of claim 1, wherein the magnetic connection assembly is positioned to secure the scraper when not in use.

6. The magnetic scraper assembly of claim 1, wherein the scraper comprises an asphalt scraper and is configured to remove asphalt from at least asphalt rakes, shovels, lutes, and boots.

7. The magnetic scraper assembly of claim 1, wherein the handle of the scraper includes a magnet for removably attaching it to metal surfaces such as a metal-handled hand tool.

8. The magnetic scraper assembly of claim 7, wherein the magnet attached to the scraper has a contoured surface for attaching to a contoured surface of the metal-handled hand tool.

9. A system comprising:
a hand tool;
a magnetic scraper having a handle and a scraper blade, wherein the scraper blade is made from a rigid, high-strength material capable of removing substances from unwanted surfaces;
a full tang extending from the scraper blade through the handle, wherein the handle generally encloses the tang and is constructed from high-strength material;
a magnetic connection assembly including a high-strength permanent magnet;
wherein the magnetic connection assembly is configured to attach the scraper to the hand tool, allowing for quick attachment and detachment.

10. The system of claim 9, wherein the magnetic connection assembly is a separate component from the scraper and configured for attachment to the hand tool comprising an asphalt hand tool.

11. The system of claim 9, wherein the magnetic connection assembly includes a protective casing for the magnet.

12. The system of claim 9, wherein the scraper blade has a reinforced edge to improve asphalt removal from an asphalt hand tool.

13. The system of claim 9, wherein the scraper is adapted for attachment to multiple hand tools interchangeably.

14. The system of claim 9, wherein the handle of the scraper includes the magnetic connection assembly and magnet for removably attaching the scraper to metal surfaces such as a metal-handled hand tool.

15. The system of claim 14, wherein the magnet of the magnetic connection assembly has a contoured surface for attaching to a contoured surface of the metal-handled hand tool.

16. A method for using a magnetic scraper assembly in operations using hand tools, the method comprising:
providing a magnetic scraper comprising a handle, a scraper blade, and a full tang enclosed by the handle, wherein the scraper blade is made from a rigid, high-strength material;
removably attaching the magnetic scraper via a magnetic connection;
decoupling the magnetic scraper by breaking the magnetic connection;
using the magnetic scraper to remove substances from unwanted surfaces;
re-coupling the magnetic connection for stowing the magnetic scraper.

17. The method of claim 16, wherein the magnetic scraper includes a magnet for creating the magnetic connection to a hand tool.

18. The method of claim 16, further comprising:
attaching a magnetic connection assembly to a hand tool for creating the magnetic connection to the magnetic scraper, wherein the magnetic connection assembly is separate from the magnetic scraper.

19. The method of claim 16, wherein the step of removably attaching the magnetic scraper via a magnetic connection comprises removably attaching the magnetic scraper via the magnetic connection to an asphalt hand tool configured to remove asphalt from at least asphalt rakes, shovels, lutes, and boots.

20. The method of claim 16, wherein the magnetic connection comprises a magnet carried by a handle of a hand tool or the handle of the magnetic scraper enabling quick and convenient access to the magnetic scraper during use.
